(19) United States
(12) Patent Application Publication
(10) Pub. No.: US 2024/0297862 A1
(43) Pub. Date: Sep. 5, 2024

(54) SERVER, TERMINAL AND COMPUTER PROGRAM

(71) Applicant: 17LIVE Japan Inc, Tokyo (JP)

(72) Inventors: Shao-Tang CHIEN, Taipei City (TW); Chin-Wei LIU, Taipei City (TW); Hsing-Yu TSAI, Taipei City (TW); Liang-Tse CHIANG, Taipei City (TW)

(21) Appl. No.: 18/456,982

(22) Filed: Aug. 28, 2023

(30) Foreign Application Priority Data
Mar. 2, 2023 (JP) 2023-031643

(51) Int. Cl. H04L 51/212; G06F 40/279; H04L 51/02

(52) U.S. Cl. CPC H04L 51/212; G06F 40/279; H04L 51/02

(57) ABSTRACT

A server for managing content in a live streaming platform, comprising: receiving a message from a user terminal of a user; determining whether the user is included in a user list in response to detecting a keyword in the message; and determining the display type of the message according to the user list the user belongs to. The present disclosure may prevent the bad user from sending messages to ruin the atmosphere of the live streaming room. It may also prevent the bad user from creating a lot of accounts to affect the environment of a live streaming platform. Therefore, the user experience may be improved.

This application is based on and claims the benefit of priority from Japanese Patent Application Serial No. 2023-031643 (filed on Mar. 2, 2023), the contents of which are hereby incorporated by reference in its entirety.

### TECHNICAL FIELD

This disclosure relates to information and communication technology, and in particular, to a server, terminal and computer program in a live streaming.

### BACKGROUND

Some APPs or platforms provide live streaming service for streamers and viewers to interact with each other. The streamers may have a performance to cheer up the viewers and the viewers may send messages or gifts to support the streamers.

The platform is like a virtual world, if the users violate rules such as sending inappropriate messages in the platform, the APP or platform provider always bans, freezes, or mute the user as a punishment. More specifically, if the messages from the users are inappropriate, they are always banned from sending messages in the stream room for the time being or forever. Non-Patent Document 1 discloses the method to limit users' messages.

However, banning the users motivates them to create more accounts to violate rules. Moreover, banning them may not stop them from sending inappropriate messages and may lead to poor user experience to the other users. Therefore, how to solve the problem while improving the user experience is very important.

### [Non-Patent Document 1]:

https://dic.nicovideo.jp/a/%E7%94%9F%E6%94%BE%E9%80%81%20% E3%82%B3%E3% 83% A1% E3%83% B3% E3%83%88ban

### SUMMARY

An embodiment of subject application relates to a server for managing content in a live streaming platform, comprising: receiving a message from a user terminal of a user; determining whether the user is included in a user list in response to detecting a keyword in the message; and determining the display type of the message according to the user list the user belongs to.

Another embodiment of subject application relates to a terminal for managing content in a live streaming platform, comprising: transmitting a message; displaying the message on the user terminal of the user in response to detecting no keyword or a first keyword in the message; and replacing the message with a template message and displaying the message on the user terminal of the user in response to detecting a second keyword in the message.

Another embodiment of subject application relates to a computer program for causing a server to realize the functions of: receiving a message from a user terminal of a user; determining whether the user is included in a user list in response to detecting a keyword in the message; and determining the display type of the message according to the user list the user belongs to.

The present disclosure may prevent the bad user from sending messages to ruin the atmosphere of the live streaming room. It may also prevent the bad user from creating a lot of accounts to affect the environment of a live streaming platform. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the bad user DB 324 of FIG. 3;

FIG. 7 shows an exemplary data structure of the keyword look-up table 330 of FIG. 3;

FIG. 8 shows an exemplary data structure of the display look-up table 332 of FIG. 3;

FIG. 9-FIG. 15 are exemplary screen images of a live streaming room screen 600 shown on the display of the streamer user terminal 20 or the viewer user terminal 30;

FIG. 16 and FIG. 17 are flowcharts illustrating an operation of the configuration of the live streaming system 1 according to some embodiments of subject application;

FIG. 18 and FIG. 19 are exemplary sequence charts illustrating an operation of the configuration of the live streaming system 1 according to some embodiments of subject application;

FIG. 20 is an exemplary hardware configuration of the information processing device according to some embodiments of subject application.

### DETAILED DESCRIPTION

Hereinafter, the identical or similar components, members, procedures, or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

There are two separate ways to cope with bad comments: by-account banning or by-comment banning. For the by-account banning, accounts of bad users are listed in a bad-user list. The listed user cannot make any comment in a live streaming. In this case, the listed user can easily realize that he/she has been banned, so that he/she can create a new account to escape from the ban. Therefore, the effect of the by-account banning is low.

For the by-comment banning, the system monitors each comment from the viewers of a live streaming. The system bans a comment which is found to be bad. There are two ways to ban a comment: replacement with a warning message or a “transparent” ban. In the case of replacement, a malicious user can easily determine which word is related to the ban by repeated trial-and-errors, so that he/she can avoid the ban and still can send a bad comment. In a scenario where a suspicious comment always is “transparent”, meaning that the sender can see the comment as is and the other users or the streamer will not see the comment, a malicious user is likely to not realize that his/her comment is banned. Therefore the transparent ban is effective against such malicious users.

However, if a normal user accidentally inputs a bad word in his/her comment, such comment is determined to be bad and becomes transparent. Then the communication between the normal user and the streamer in a live streaming becomes awkward. Because the normal user believes that his/her comment is delivered to the streamer whereas the streamer actually does not receive the comment, the two will not be on the same page. As such, any of the prior art ways to cope with bad comments is not optimal.

In some embodiments of this disclosure, a two-step process is introduced. In some embodiments, the system monitors each comment input by the viewers of a live streaming. If the system finds that the comment is suspicious or is to be banned, then the system refers to a list where IDs of malicious users are stored. If the ID of the sender of the suspicious comment is not included in the list, the system replaces the suspicious comment with a default warning message. The warning message is shown to the sender. If the ID is included in the list, the system shows the original suspicious comment to the sender as is whereas the suspicious comment is not shown to other viewers or the streamer. By doing so, a malicious user is likely to not realize that his/her comment is banned and a normal user realizes that his/her comment was not shown.

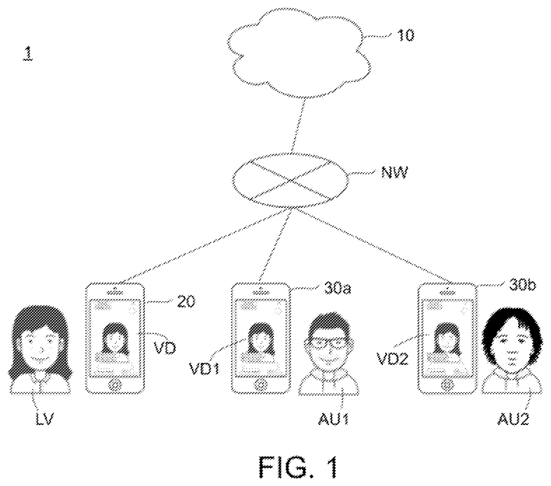

FIG. 1 shows a schematic configuration of a live streaming system 1 according to some embodiments of subject application. The live streaming system 1 provides a live streaming service for the streaming streamer (may also be referred as live or streamer) LV and viewer (may also be referred as audience) AU (AU1, AU2 . . . ) to interact mutually in real time. As shown in FIG. 1, the live streaming system 1 may include a server 10, a user terminal 20 and a user terminal 30(30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10 and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations to interact with the streamer, such as messaging, commenting, or cheering the streamer, by the user terminal 30. The streamer, who provides the contents, may respond to the message or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming. Common Media Application Format, Web Real-Time Communications, Real-Time Messaging Protocol, MPEG DASH or the like. The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size, or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a message on the contents of the streamer LV into the user terminal 30a, the server 10 will display the message on the user terminal 20 of the streamer in real time, and also display on the user terminal 30a, 30b of the viewer AU1, AU2 respectively. If the streamer LV responds to the message, the response may be outputted as the text, image, video, or audio from the terminal 30a, 30b of the viewer AU1, AU2, so that the communication of the streamer LV and viewer LV may be realized. Therefore, the live streaming system may realize the live streaming of two-way communication.

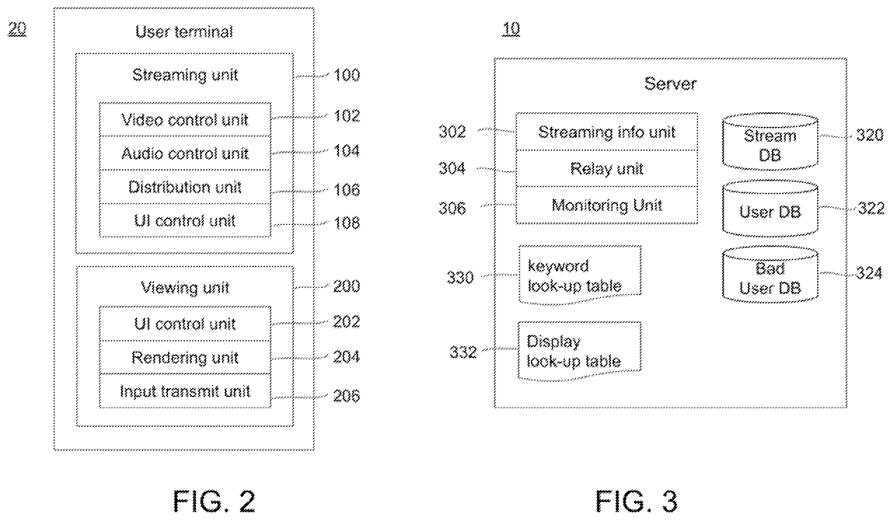

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces, and displays the streaming data on the display. The UI control unit 108 shows the object for operating or the object for instruction-receiving on the display and is configured to receive the tap input from the streamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the messages inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a message, sending a gift, following, or unfollowing an user, voting in an event, gaming or the like. For example, the input transmit unit 206 may generate gift information and transmit to server 10 via the internet NW if the user terminal of the viewer clicks a gift object on the screen in order to send a gift to the streamer.

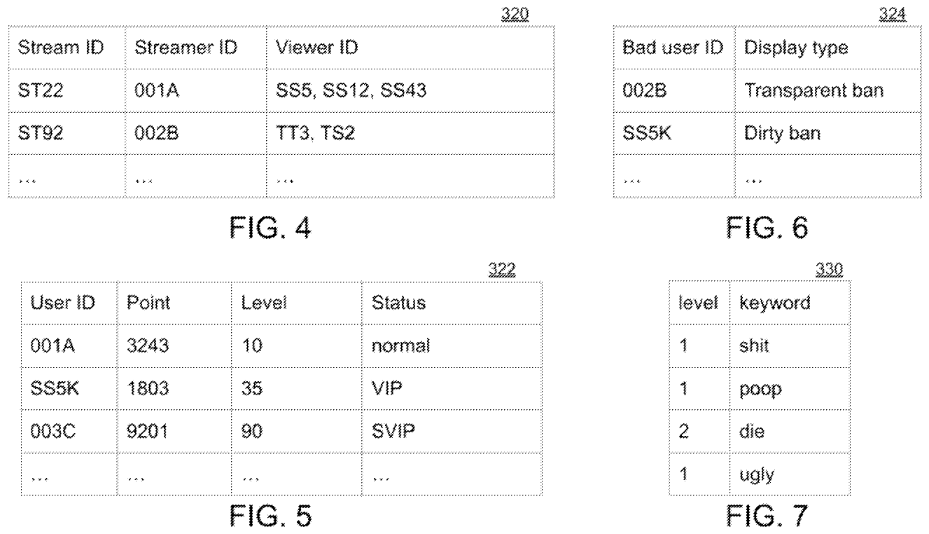

FIG. 3 is a schematic block diagram of the server 10 according to some embodiments of the subject application. The server 10 may include streaming info unit 302, relay unit 304, monitoring unit 306, stream DB 320, user DB 322, bad user DB 324, keyword look-up table 330 and display look-up table 332.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30.

The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The monitoring unit 306 is configured to monitor the actions, behaviors, or operations the user of the user terminal performs in the platform. The user may perform operations on the platform, and the operations may be transmitted from the user terminal to the server 10 to realize the operation. The monitoring unit 306 may monitor the operations from the user terminal to check if there are any violations in the platform.

In some embodiments, the operation may be any possible operations the user could perform on the platform. For example, the operation may be messaging, commenting, gifting, gaming or the like. In some embodiments, the user may send messages in the live streaming room and the messages may include a keyword that is not complying with the rules in the APP or platform (for example, the operator of live streaming platform interests or like). The rules may be determined flexibly by the APP or platform provider, and the APP or platform provider may receive the agreement from the user of the user terminal when the user registers their account or the like.

The monitoring unit 306 may monitor the message according to the keyword look-up table 330. More specifically, the monitoring unit 306 may look up the keyword look-up table 330 to check if there is any inappropriate content in the message. For example, the viewer may send a message of “how is your day” to interact with the streamer. If there are no keywords detected in the message, the server 10 may transmit the message to the streamer and the other user to realize the interaction. In some embodiments, insulting words are always considered as a violation in a platform. If a viewer sends a message of “shit”, “die” or “you are ugly” in the streaming room, the monitoring unit 306 may detect the violation of the message from the user terminal.

In some embodiments, the monitoring unit 306 may mute, ban, or freeze the account, terminal or device of the user. For example, the user may receive a message indicating that the viewer is muted and could not send a message in the live streaming room. In some embodiments, the user who is being muted could not send messages in the live streaming room. In some embodiments, the user who is being muted could send messages but the messages would not be transmitted to the streamer and the other users.

In some embodiments, if a user is being muted, the user may receive a notification related to the information of being muted, for example, when the user enters a live streaming room for the first time or sends the first message. In some embodiments, the user may still type and send messages after the notification disappears. However, the messages may only be displayed on the user terminal 30 of the user and would not be transmitted to the streamer and the other user.

In some embodiments, the monitoring unit 306 may replace the message with a template message and display the template message in the user terminal 30 of the user. For example, the template message may be the message to indicate that there is an inappropriate word in the message such as “there is a dirty word in this message” or the like. According to the embodiments, the user who accidentally sends messages with dirty words may be notified and the user experience may be improved.

In some embodiments, the monitoring unit 306 may only replace the keyword with symbols and display messages in the user terminal 30 of the user. For example, if the user sends a message of “you have shit” and the “shit” may be replaced with ****, so the message of “you have ****” may be displayed on the user terminal 30 of the user.

In a live streaming platform, the streamers may have a performance to cheer up the viewers and the viewers may send gifts to support the streamers. The gift is electronic data that may be purchased in exchange for points in the live streaming platform. Here, the point is the electronic value circulated within the live streaming platform. The points may be purchased by the user through the normal channels provided by the APP or platform provider.

However, some users may obtain cheap points through illegal channels and then send messages to sell the illegal points in a live streaming room. For example, the message may be “contact me for cheap points” or the like. Here, the illegal channels may be the channels not provided by the APP or platform provider, and the illegal points may be the points from illegal channels. Therefore, the messages with the information of illegal points are always considered as a violation in a platform. Moreover, messages with the information of fraud, asking for personal information, unverified link or the like may also be considered as a violation in a platform.

In some embodiments, if a user sends messages including inappropriate contents such as illegal points, the monitoring unit 306 may mute, ban, or freeze the terminal, account or device of the user. However, there is a possibility for the users to create more accounts or use other devices if they found out they couldn't send messages at all.

In some embodiments, the monitoring unit 306 may replace the message with a template message and display the template message in the user terminal 30 of the user. However, there is also a possibility for the users to change the phrase of the message or try other similar wordings in order to avoid a certain keyword in the message.

For this kind of user, they send suspicious messages to prompt the other users to add their account or click unverified links in order to obtain illegal benefits. They always send the messages without interacting with the streamer and the other users. In some embodiments, the monitoring unit 306 may display the message in the user terminal 30 of the user and prevent the message from being transmitted to the streamer and the other user in the live streaming room. According to the embodiments, the users may not be aware of their messages being blocked or hidden so that they would not create new accounts or continually try other similar wordings. Moreover, the streamer and the other users may not be affected by the messages. Therefore, the quality of the platform and the user experience may be improved.

In some embodiments, if a keyword in the message is detected, the monitoring unit 306 may determine the display type of the message according to the display look-up table 332. In other words, the monitoring unit 306 may look up the display look-up table 332 to determine the display type of the message if the keyword in the message is detected.

In some embodiments, the monitoring unit 306 may determine the user group the user belongs to according to the keyword in the message. For example, if the user sends messages related to illegal points, the monitoring unit 306 may tag the user as an illegal topper and store the information in the user DB 322 or bad user DB 324 or the like.

In some embodiments, the monitoring unit 306 may determine the display type of the message in the user terminal 30 of the user, the other viewers, the streamers or the like. More specifically, the monitoring unit 306 may determine the way to display the message in the user terminal 30 of the user and whether to transmit the message to the streamer and the other viewers for display. In some embodiments, the detection of the keyword and the determination of the user's status in the bad user DB may be performed by a language model such as ChatGPT or the like.

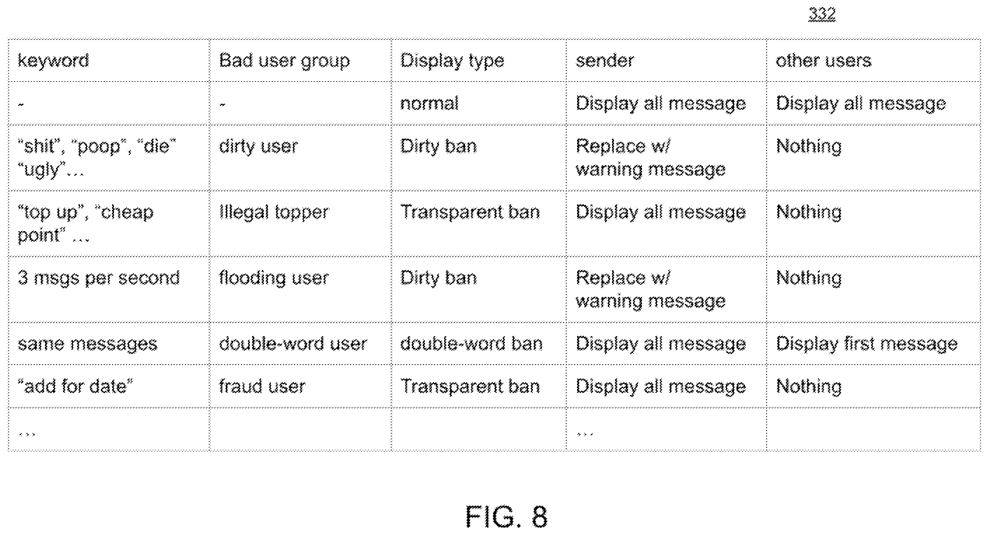

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live streaming system 1, a streamer ID for identifying the streamer who provides the live stream, and a viewer ID for identifying a viewer of the live stream, in association with each other.

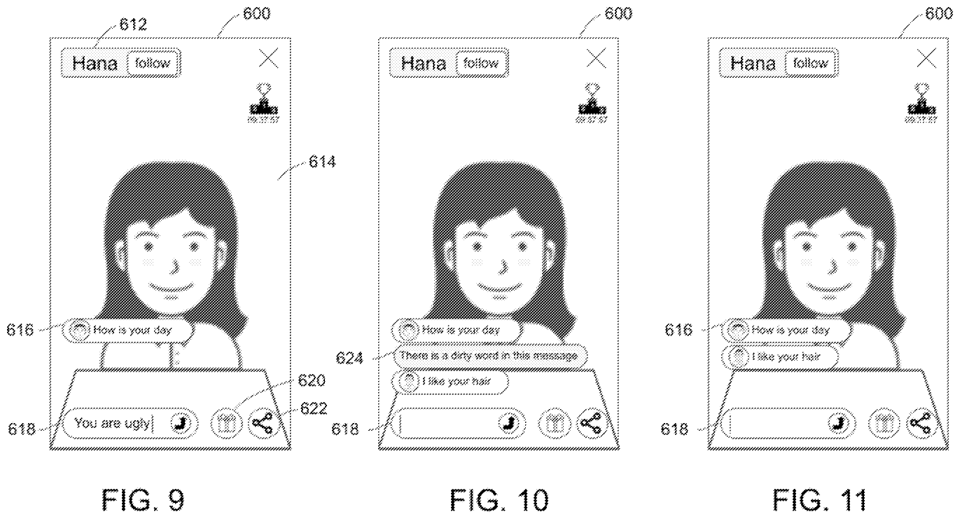

FIG. 5 shows an exemplary data structure of the user DB 322 of FIG. 3. The user DB 322 holds information regarding users. The user DB 322 stores a user ID for identifying a user, points that the user has, the level of the user, and the status of the user, in association with each other.

The level is an indicator of the amount of user activity or engagement on the live streaming platform. The level of the user is raised by giving gifts as a viewer, performing live streams as a distributor, participating in events, and the like. The server 10 calculates the level of the user from the history of the user's activity.

The status is an identity or membership status of the user on the live streaming platform. The status of the user may be obtained by purchasing, participating in events or the like. The server 10 may determine the status of the user from the purchase record of the user or the like.

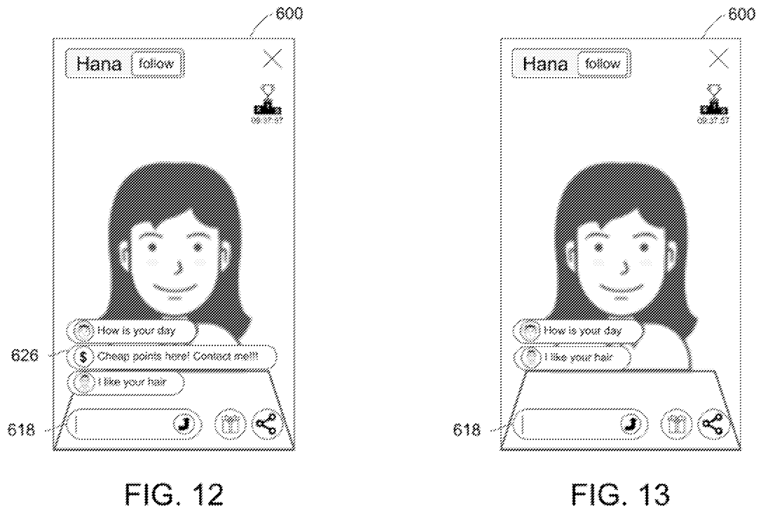

FIG. 6 shows an exemplary data structure of the bad user DB 324 of FIG. 3. In some embodiments, server 10 may store information of a bad user in the user DB 322 by, for example, tagging the user in user DB 322 or the like. In some embodiments, server 10 may include a separated database such as the bad user DB 324 to store the information of a bad user. Here, the bad user may be referred to as the user who violates the rules in the APP or platform such as sending inappropriate messages or the like.

The bad user DB 324 holds information regarding the user ID of the bad user. In some embodiments, the bad user DB 324 stores a user ID of the bad user for identifying a bad user, and a display type for identifying the way to display messages from the bad user, in association with each other. In some embodiments, the bad user DB 324 may include at least one list to identify the bad user. For example, the bad user DB 324 may include a dirty ban list and the transparent ban list, and each list may list the corresponding bad user.

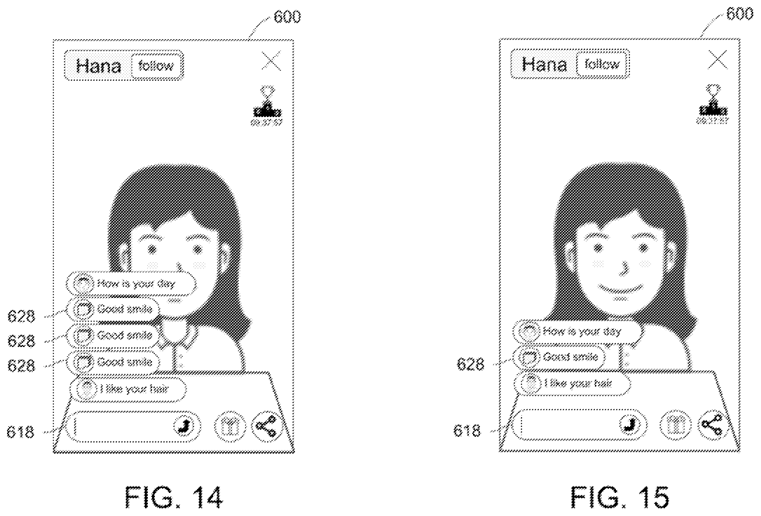

FIG. 7 shows an exemplary data structure of the keyword look-up table 330 of FIG. 3. The keyword look-up table 330 may be configured to store the keyword which violates the rules in the APP or platform. In some embodiments, the keyword look-up table 330 may include the keyword and its corresponding level, in association with each other. The level of the keyword may be an indicator of the severity of the keyword.

In some embodiments, the keyword may be regularly and dynamically updated based on user feedback, moderation reports, or machine learning algorithms that analyze the patterns of inappropriate or offensive language use. In some embodiments, the keyword may be determined flexibly according to the practical need.

In some embodiments, the message may include any kind of messages the user may send in the live streaming room such as text, audio, video or the like. In some embodiments, the keyword may be a specific word, term, phrase, sentence, symbol, emoji, or the like in the message. In some embodiments, the keyword may also be audio, video or the like. In some embodiments, the keyword may also be specific operation or behavior the user may perform in the live streaming platform. For example, the keyword may also be flooding the streaming room with messages, sending repeated messages, sending meaningless messages or the like.

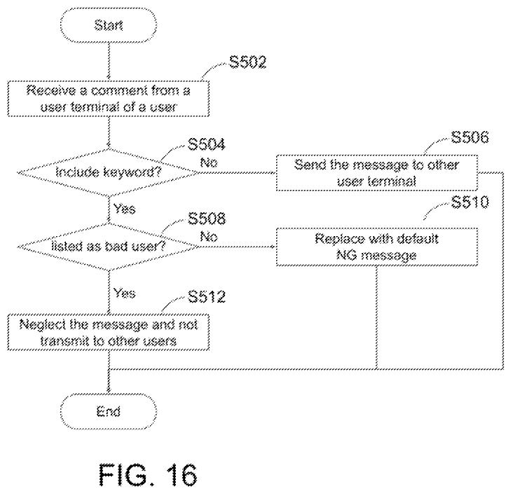

FIG. 8 shows an exemplary data structure of the display look-up table 332 of FIG. 3. The display look-up table 332 stores a keyword for identifying keywords in the messages, a bad user group for identifying the bad user group the user belongs to, and the display type for identifying the way to display the message, in association with each other.

In some embodiments, the display look-up table 332 may further include detailed information of the display type such as the “sender” for identifying the way to display the message in the sender's terminal, and the “other users” for identifying the way to display the message in the streamer and other viewers' terminal.

For example, if no keyword is detected from the user's message, the user may not be tagged as any bad user group and the display type of the message may be “normal”. More specifically, the display type of “normal” refers to the message being displayed on the user terminal 30 of the user and also being transmitted to the other users for display.

If a keyword such as “shit”, “poop”, “die” or “ugly” is detected from the user's message, the user may be tagged as a dirty user and the display type of the message may be “Dirty ban”. More specifically, the display type of “dirty ban” refers to the message being replaced with a template message and displayed only on the user terminal 30 of the user, without being transmitted to the other users for display.

If a keyword such as “top up” or “cheap point” is detected from the user's message, the user may be tagged as illegal topper and the display type of the message may be “Transparent ban”. More specifically, the display type of “Transparent ban” refers to the message being displayed on the user terminal 30 of the user, without being transmitted to the other users for display.

In some embodiments, the keyword may also be the operation or behavior the user performs in the live streaming room. For example, the user may send a lot of messages in a short period of time such as 3 messages per second. If the operation or behavior is detected from the user's message, the user may be tagged as flooding user and the display type of the message may be “flooding ban” or may be the same as “dirty ban” or the like. In some embodiments, the keyword, bad user group and display type may be determined flexibly according to the practical need.

In some embodiments, the feature of monitoring and display messages may also be realized in the terminal side, which means that the user terminal 30 may include the function as monitoring unit 306, keyword look-up table 330, display look-up table 332 or the like. The user terminal 30 may monitor the message from the user by detecting the keyword in the message and determining the display type of the message on the user terminal 30 of the user or the like. In some embodiments, the user terminal may update the keyword look-up table 330 and display look-up table 332 periodically from server 10 to realize the feature.

In some embodiments, if a keyword is detected in the messages, the messages may not be transmitted to the server 10. In some embodiments, the messages may be transmitted to server 10, and server 10 may neglect the messages with keywords. According to the embodiments, it is not necessary for server 10 to handle the messages with keywords. Therefore, the loading for the server 10 may be reduced and the quality of the server 10 may be improved.

In some embodiments, the server 10 may neglect the messages by displaying the message on the user terminal 30 of the user and not transmitting the message to the other users. In some embodiments, displaying the message on the user terminal 30 of the user may be realized by the user terminal 30 or by the instruction from the server 10 or the like. According to the embodiments, the quality of server 10 may be improved.

In some embodiments, the information of violation may also be transmitted from the user terminal 30 to the server 10 and the server 10 may store the information in the corresponding database such as bad user DB 324. In some embodiments, the information of violation may include, for example, the sender ID, keyword, keyword type, display type or the like.

In some embodiments, the monitoring unit 306 may tag the user as a specific user according to the information of violation. For example, the monitoring unit 306 may list the user as a dirty user or illegal topper in the bad user DB 324. The monitoring unit 306 may list the user in the dirty ban list or transparent ban list in the bad user DB 324. Therefore, the monitoring unit 306 may refer to the bad user DB 324 to determine the display type of the message from the user terminal 30 of the user.

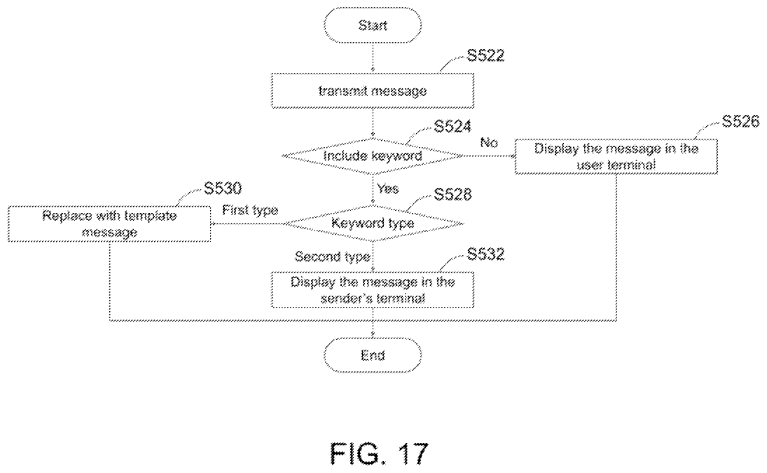

FIG. 9 and FIG. 10 are exemplary screen images of a live streaming room screen 600 shown on the display of the user terminal 30, who sends the messages. FIG. 11 is an exemplary screen image of a live streaming room screen 600 shown on the display of the user terminal 20 or 30, who is the other user in the live streaming room.

Once the viewer selects and enters a live streaming room, a live streaming room screen 600 of the streamer may be shown on the display. The live streaming room screen 600 may include a streamer info object 612, streamer image 614, message zone 616, message input box 618, gifting object 620, sharing object 622 or the like. The streamer info object 612 may include information of the streamer. In some embodiments, the streamer info object 612 may include a button for the viewer to follow the streamer or the like.

The streamer image 614 may be obtained by reproducing the video data. The message zone 616 may include the interaction message in the streaming room such as messages from the user, gifting information, server notification or the like. The message input box 618 may allow the user to enter a message and send it to the live streaming room. The gift object 620 may be the object for the viewer to tap in order to send a gift to the streamer. The sharing object 622 may be the object for the viewer to tap in order to share the live streaming room with other users.

In some embodiments, a viewer may tap on the message input box 618 in the viewer user terminal 30 to send a message to the streamer. For example, the viewer may send a message of “how is your day” to interact with the streamer. In some embodiments, if a viewer sends a message of “you are ugly” in the streaming room as shown in FIG. 9, the monitoring unit 306 may detect keyword “ugly” in the message according to the keyword look-up table 330, and then determining the display type of the message according to the display look-up table 332.

The word “ugly” is a keyword according to the keyword look-up table 330. According to the display look-up table 332, the message with the keyword “ugly” should be replaced with a template message and displayed on the user's terminal, and the message should not be transmitted to the other users. As shown in FIG. 10, the message is replaced with a template message 624 such as “there is a dirty word in this message” and the template message 624 is displayed on the user terminal 30 of the sender. Since the message is not transmitted to the other users, the message is not shown in the user terminal 20, 30 of the other user as shown in FIG. 11.

FIG. 12 is an exemplary screen image of a live streaming room screen 600 shown on the display of the user terminal 30, who sends the messages. FIG. 13 is an exemplary screen image of a live streaming room screen 600 shown on the display of the user terminal 20 or 30, who is the other user in the live streaming room.

As shown in FIG. 12, the user sends a message 626 of “cheap points here! Contact me” in the live streaming room. Since there is a keyword “cheap points” in the message, the monitoring unit 306 may determine the display type as “transparent ban”, which is to display the message in the sender's terminal and not transmit the message to the other users. As shown in FIG. 12, the message 626 is displayed on the user terminal 30 of the user who sends the messages. As shown in FIG. 13, the message is not transmitted and displayed on the user terminal of the other user in the live streaming room.

In some embodiments, the monitoring unit 306 may monitor the behavior or operation the user performs in the live streaming room. The monitoring unit 306 may determine to transmit or display all messages, no messages, or a portion of the message to the user terminal of the sender or the other users.

FIG. 14 is an exemplary screen image of a live streaming room screen 600 shown on the display of the user terminal 30, who sends the messages. FIG. 15 is an exemplary screen image of a live streaming room screen 600 shown on the display of the user terminal 20 or 30, who is the other user in the live streaming room. As shown in FIG. 14, the user may send messages in the live streaming room. For example, the user may flood the messages on purpose, or send out repeated messages accidentally due to a weak network. The user may send meaningless messages in order to complete a mission or the like. All the behavior or operation may ruin the atmosphere and lower the user experience.

As shown in FIG. 14, the user sends three messages 628 of “Good smile” in a row. The monitoring unit 306 may monitor the messages and determine the display type of the messages in the live streaming room. As shown in FIG. 14, all the messages the user sent may be displayed on the user terminal 30 of the user. As shown in FIG. 15, only one message may be transmitted and displayed on the user terminal 20, 30 of the other users. According to the embodiments, the sender may understand that multiple messages are sent due to accidentally clicking or weak network. The other user may receive only one message from the repeated message and the user experience may be improved.

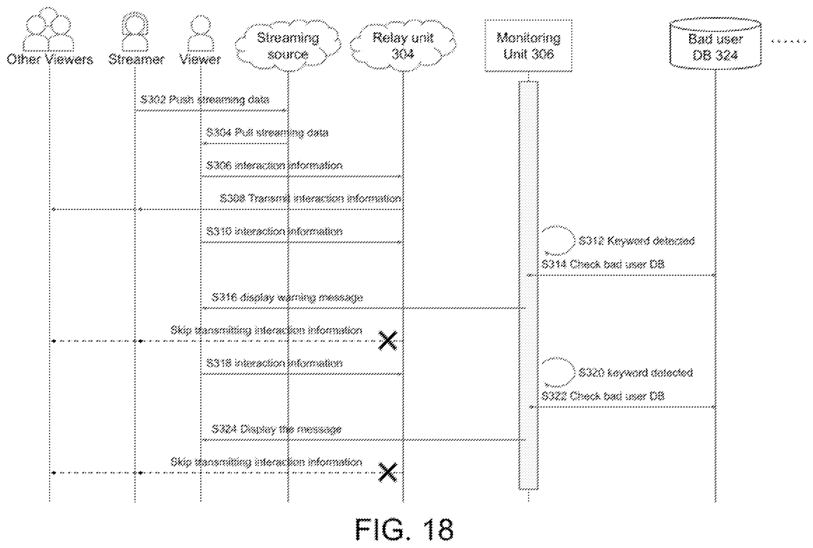

The operation of live streaming system 1 with the above configuration will be now described. FIG. 16 is a flowchart illustrating an operation of the configuration of server 10 in the live streaming system 1 according to some embodiments of subject application. Once a user enters a live streaming room, the user may perform an operation by the user terminal to interact with a streamer. In some embodiments, the operation may include sending messages, sending gifts, following, unfollowing, voting, gaming or the like.

The server 10 may receive the message from the user terminal of the user (S502). The monitoring unit 306 may monitor the message by detecting a keyword in the message. For example, the monitoring unit 306 may scan the message to detect whether it contains a specific keyword. If the message does not include a specific keyword (No in S504), the relay unit 304 may transmit the message to other user terminals of the users such as streamers and the other user (S506). If the message includes a specific keyword such as dirty word or the like (Yes in S504), the monitoring unit 306 may determine whether the user is included in a specific user list (S508). In some embodiments, the monitoring unit 306 may refer to the user DB 322 or the bad user DB to check if the user is listed in or tagged as a specific user list.

If the user is not included in a specific user list (No in S508), the relay unit 304 may replace the message with a template message. In some embodiments, server 10 may transmit the template message to the user terminal 30 of the user to display the template message. In some embodiments, server 10 may not transmit the message to the other user and streamer. According to the embodiments, the user experience may be improved. In some embodiments, server 10 may further transmit the template message to the other users and streamer to display the template message. According to the embodiments, the streamer and the other user may know the message from the user includes dirty words.

If the user is included in the specific user list (Yes in S508), the relay unit 304 may neglect the message (S512). For example, if the user is found to be included in the illegal topper user list, the relay unit 304 may neglect the message, and no further action is taken. More specifically, the relay unit 304 may just let the user terminal 30 to display the message and not transmit the message to the other user and the streamer.

FIG. 17 is a flowchart illustrating an operation of the configuration of user terminal 30 in the live streaming system 1 according to some embodiments of subject application. The user may transmit a message by the user terminal 30 (S522). The input transmit unit 206 may monitor the message by detecting a keyword in the message. For example, the viewing unit 206 may scan the message to detect whether it contains a specific keyword. If the message does not include a keyword (No in S524), the rendering unit 204 may display the message in the user terminal 30 of the user. In some embodiments, the input transmit unit 206 may further transmit the message to server 10.

If the message includes a keyword (Yes in S524), the viewing unit 206 may further check types of the keyword (S528). In some embodiments, the input transmit unit 206 may not transmit the message to server 10 if keywords in the message are detected. In some embodiments, the keyword may be dirty words such as “shit”, “ugly” or the like. In some embodiments, the keyword may be the information of illegal points in the live streaming platform such as “contact me for cheap points” or the like.

If the message includes a first type of keyword such as dirty word (first type in S528), the rendering unit 204 may replace the message with template message (S530) and display the template message on the user terminal 30 of the user. In some embodiments, the first type of keyword may be the keyword related to dirty words such as “shit”, “ugly” or the like. According to the embodiments, if the user sends the messages with dirty words on purpose, a template message may be displayed to notify the user that the message is inappropriate. If the user accidentally sends the messages with dirty words, the template message may also help the user understand that the message is inappropriate.

If the message includes a second type keyword such as illegal points (second type in S528), the rendering unit 204 may display the message in the user terminal 30 of the user. In some embodiments, the second keyword may be the keyword related to the information of illegal points or the like. More specifically, if the user sends the messages with illegal points (the user may be referred to as “illegal topper”), the input transmit unit 206 may not transmit the message to server 10 and the rendering unit 204 may still display the message in the user terminal 30. According to the embodiments, the illegal topper may not be aware that the message is not transmitted to the other users and streamers. The illegal topper may think that the message is transmitted successfully. Therefore, it may prevent the illegal topper from creating a lot of accounts to send messages related to illegal points or the like.

In some embodiments, the process of the comment ban splits into two routes in order not to let illegal toppers be aware of their messages being blocked. This prevents them from continually trying other similar wordings to send the message. In other words, the system shows the original comment they typed in order to make them believe that the system has shared their messages to everyone. Also, the design of some embodiments is not to act rashly or not to alert the enemy. The system does not let the illegal toppers know that it is keeping eyes on them. The illegal toppers usually create thousands of new accounts. If they found out they couldn't comment at all, they would just create another new account to do the same thing.

In some embodiments, the display of messages will vary depending on the input user, either replacing the message with a template message such as “the message include dirty word” or implementing a transparent ban, where the input message will only be visible to the input user.

In some embodiments, the keyword look-up table 330 or the display look-up table 332 may be the same, but the treatment may be adjusted according to the attribute of the input user such as the level, status or the like. In some embodiments, there may be more than one keyword look-up table 330 or display look-up table 332 for the users with different status or different levels separately. For example, there may be different keyword look-up tables for general users, VIP users, Super VIP (SVIP) users or the like. For example, the keyword for general users is stricter than that for VIP or SVIP. For example, the SVIP is allowed to say more keywords such as “ugly” than the other users or the like. In some embodiments, the treatment of the user with different levels or status may be determined flexibly according to the practical need.

In some embodiments, the treatment may also be determined according to the viewer group or streamer group. In some embodiments, the keyword and display type may also be adjusted by the streamer or the like. In some embodiments, server 10 may allow streamers to adjust the keyword, set the level of the keyword, or assign moderators for different live streaming according to the topic, viewers, or the like in a live streaming room. In some embodiments, the keyword and display type may also be determined according to the previous violation of the user. For example, stricter keyword look-up tables may also be applied for the user with a violation record.

In some embodiments, the treatment may also be determined according to the contribution or engagement of the user in the APP or platform. For example, the top spender may be applied with a lenient or flexible keyword look-up table, or the transparent bans may not be applied on the top spenders.

In some embodiments, the keyword and display type may also be determined flexibly. For example, there may be one keyword look-up table for all the users, and the monitoring unit 304 may adjust the display type of the message according to the users separately. In some embodiments, there may be more than one keyword look-up table for different users or user groups. The users may be classified according to the level, status, streamer, viewer, violation record, age, gender, generation, user attribute, user behavior or the like. For example, the transparent ban may be applied to the teenage boys, who are considered to be more susceptible to trolling. Moreover, the users who have been muted or banned multiple times could be added to a transparent ban list or the like. In some embodiments, the keyword and display type may be determined according to the practical need.

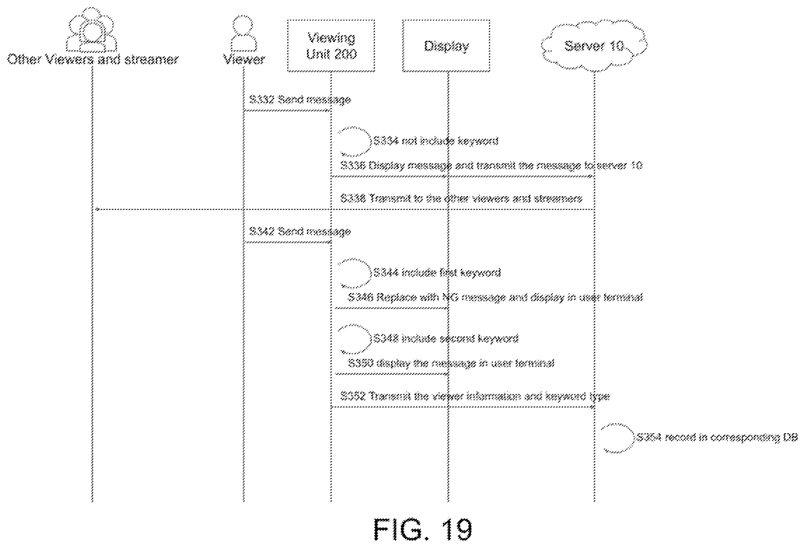

FIG. 18 is an exemplary sequence chart illustrating an operation of the configuration of the live streaming system 1 according to some embodiments of subject application. In some embodiments, a streamer may start a live streaming by pushing the streaming data to a streaming source (S302). The viewer may pull the streaming data by tapping on the streamer the viewer would like to watch (S304). During the live streaming, the viewers may interact with the streamer by sending interaction information such as messages, gifts, animations or the like (S306). In some embodiments, the monitoring unit 306 may monitor the action or the interaction among users of user terminals. If there are no keywords detected in the messages, the relay unit 304 may receive and transmit the interaction information to the streamer and other viewer in the live streaming room (S308).

The user may send other interaction information to streamers by sending messages or the like (S310). If the monitoring unit 306 detects a keyword from the message (S312), the monitoring unit 306 may check whether the user is listed in the bad user DB (S314). In some embodiments, the bad user DB 324 may include the user ID and the display type of messages from the user. In some embodiments, the bad user DB 324 may include lists such as dirty ban list, transparent ban list or the like. If the user is listed in the dirty ban list, the monitoring unit 306 may replace the message with a template message and transmit to the viewer for displaying the template message in the user terminal (S316).

In some embodiments, if a keyword is detected, relay unit 304 may prevent the message or the template message from transmitting to the streamer and the other viewer. In some embodiments, if a keyword is detected and the dirty ban is applied, the relay unit 304 may transmit the template message instead of the message to the streamer and the other viewer. According to the embodiments, the streamer and the other viewers in the live streaming room may be made aware of the presence of inappropriate messages, but not the specific content of the messages. This helps to prevent the atmosphere of the room from being negatively impacted.

The viewers may send other messages or the like (S318). The monitoring unit 306 may detect a keyword in the message (S320) and check whether the user is listed in the bad user DB if the keyword is detected (S322). If the user is listed in the transparent ban list, the monitoring unit 306 may transmit the message to the viewer for displaying the message in the user terminal (S324).

In some embodiments, if a keyword is detected and the transparent ban is applied, the relay unit 304 may prevent the message from transmitting to the streamer and the other viewer. According to the embodiments, the illegal user may not be aware of their messages being blocked. Therefore, the illegal user would not continually try other similar wordings to send the message, and the user experience in the live streaming room may be improved.

FIG. 19 is an exemplary sequence chart illustrating an operation of the configuration of the live streaming system 1 according to some embodiments of subject application. In some embodiments, the terminal side and server side may cooperate to realize the feature. More specifically, the keyword detection and display type may be realized in the terminal side and the recording of bad users may be realized in the server side.

As shown in FIG. 19, the viewers may send messages by the viewing unit 200 (S332). If the viewing unit 200 does not detect a keyword in the message (S334), the viewing unit 200 may display the message in the display of the user terminal of the user and transmit the message to the server 10 (S336). The server 10 may further transmit the message to the other viewers and streamers to realize the interaction among viewers and streamers (S338).

The viewers may send other messages or the like (S342). If the viewing unit 200 detects a first keyword such as “shit” or “ugly” in the message (S344), the viewing unit 200 may replace the message with a template message and display the message in the display of the user terminal of the user (S346). If the viewing unit 200 detects a second keyword such as “cheap points”, “add me for date” in the message (S348), the viewing unit 200 may just display the message in the display of the user terminal of the user (S350).

In some embodiments, if a keyword is detected, the viewer unit 200 may not transmit the message to the server 10. According to the embodiments, the loading for the server 10 may be reduced and the quality of the server 10 may be improved. In some embodiments, if a keyword is detected, the viewer unit 200 may transmit the viewer information and keyword type to the server 10 (S352). The server 10 may record the related information in a corresponding DB such as bad user DB or the like.

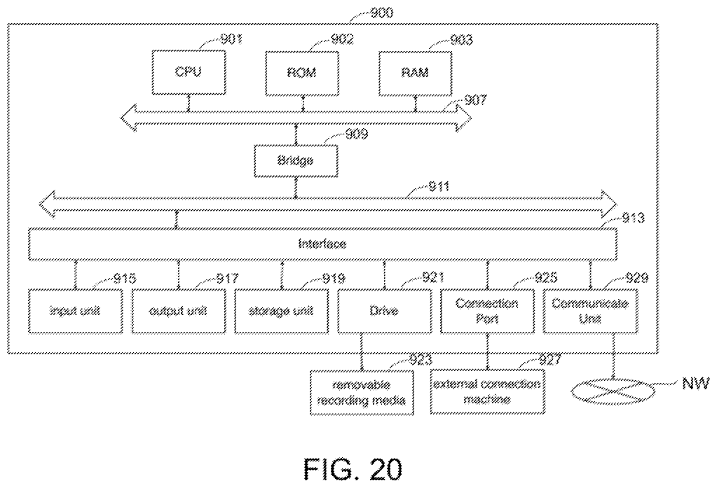

FIG. 20 is a schematic block diagram of computer hardware for carrying out a system configuration and processing according to some embodiments of subject application. The information processing device 900 in FIG. 20 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input unit |
| 30, 30a, | User terminal | 302 | Providing unit |
| 30b | | | |
| 304 | Relay unit | 306 | Monitoring Unit |
| 320 | Stream DB | 322 | User DB |
| 324 | Bad user DB | 330 | keyword look-up table |
| 332 | Display look-up table | 600 | screen |
| 612 | Streamer info object | 614 | Streamer image |
| 616 | Message zone | 618 | message input box |
| 620 | gift object | 622 | sharing object |
| 624 | template message | 626, 628 | message |
| 900 | Information processing | 901 | CPU |
| | device | | |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording | 925 | Connection port |
| | medium | | |
| 927 | External connection | 929 | Communication unit |
| | device | | |
| LS | Live streaming | LV | Streamer |
| NW | Network | SP | Specific portion |
| AU1, AU2 | | | Viewer |
| S502-S512, | | Step | |
| S522-S532 | | | |
| S302-S324, | | | |
| S332-S354 | | | |
| VD, VD1, | | | Video |
| VD2 | | | |

What is claimed is:

1. A server for managing content in a live streaming platform, comprising one or a plurality of processors, wherein the one or plurality of processors execute a machine-readable instruction to perform:
receiving a message from a user terminal of a user;
determining whether the user is included in a user list in response to detecting a keyword in the message; and
determining the display type of the message according to the user list the user belongs to.

2. The server according to claim 1, further comprising:
neglecting the message in response to the user being included in a first user list;
replacing the message with a template message and displaying the template message on the user terminal of the user in response to the user being included in a second user list.

3. The server according to claim 2, further comprising:
neglecting the message further includes displaying the message on the user terminal of the user and not transmitting the message to the other users.

4. The server according to claim 1, wherein
the user list is determined by the user's historical messages, historical violations, level of engagement with the live streaming platform, or membership status.

5. The server according to claim 1, wherein
the keyword is defined in a keyword look-up table; and
there is one keyword look-up table for all the users, or more than one keyword look-up table for different users, and
the users are classified according to the level, status, streamer, viewer, violation record, age, gender, generation, user attribute.

6. The server according to claim 1, wherein
the keyword is updated based on user feedback, moderation reports, or machine learning algorithms that analyze the patterns of inappropriate or offensive language use.

7. The server according to claim 1, wherein
the server allows streamers to adjust the keyword, set the level of the keyword, or assign moderators for different live streaming according to topic or viewers in a live streaming room.

8. The server according to claim 1, wherein
the detection of the keyword is performed by a language model.

9. A terminal for managing content in a live streaming platform, comprising one or a plurality of processors, wherein the one or plurality of processors execute a machine-readable instruction to perform:
transmitting a message;
displaying the message on the user terminal of the user in response to detecting no keyword or a first keyword in the message; and
replacing the message with a template message and displaying the message on the user terminal of the user in response to detecting a second keyword in the message.

10. A non-transitory computer-readable medium including program instructions, that when executed by one or more processors, cause the one or more processors to execute:
receiving a message from a user terminal of a user;
determining whether the user is included in a user list in response to detecting a keyword in the message; and
determining the display type of the message according to the user list the user belongs to.
